(19) United States
(12) Patent Application Publication
(10) Pub. No.: US 2012/0139468 A1
(43) Pub. Date: Jun. 7, 2012

(54) MULTI-ROTATION HOBBY SERVO MOTORS

(75) Inventor: Brian T. Pettey, Winfield, KS (US)

(73) Assignee: ROBOTZONE, LLC, Winfield, KS (US)

(21) Appl. No.: 13/308,981

(22) Filed: Dec. 1, 2011

Related U.S. Application Data
(60) Provisional application No. 61/419,134, filed on Dec. 2, 2010.
(60) Provisional application No. 61/422,793, filed on Dec. 14, 2010.

(51) Int. Cl. G05B 11/01; G05B 1/04

(52) U.S. Cl. 318/652; 318/671; 318/653

(57) ABSTRACT

Multi-rotation hobby servo motors are provided. In one embodiment, a hobby servo motor comprises a rotatable output shaft, a feedback mechanism, and a control circuit. The feedback mechanism generates a feedback signal that is indicative of rotation of the rotatable output shaft, and the control circuit utilizes the feedback signal to generate a control signal for the rotatable output shaft. The feedback mechanism is optionally an encoder such as, but not limited to, a magnetic encoder, an optical encoder, a rotary encoder, or a linear encoder.

### REFERENCE TO RELATED CASES

The present application is a non-provisional application that is based on and claims the priority of provisional applications Ser. No. 61/419,134, filed on Dec. 2, 2010, and Ser. No. 61/422,793, filed on Dec. 14, 2010, the contents of which are hereby incorporated by reference in their entirety.

### BACKGROUND

A servo motor (a.k.a. simply a “servo”) is a device having a rotatable output shaft. The output shaft can typically be positioned to specific angular positions in accordance with a coded signal received by the servo. It is common that a particular angular position will be maintained as long as a corresponding coded signal exists on an input line. If the coded signal changes, the angular position of the shaft will change accordingly. Control circuits and a potentiometer are typically included within the servo motor casing and are functionally connected to the output shaft. Through the potentiometer (e.g., a variable resistor), the control circuitry is able to monitor the angle of the output shaft. If the shaft is at the correct angle, the motor actuates no further changes. If the shaft is not at the correct angle, the motor is actuated in an appropriate direction until the angle is correct.

There are different types of servos that include output shafts having varying rotational and torque capabilities. For example, the rotational and/or torque capability of an industrial servo is typically less restricted than that of a hobby servo. That being said, hobby servos are generally available commercially at a cost that is much less than that associated with industrial servos.

Because hobby servos are relatively small and inexpensive, they are popular within the hobby-mechanical industry for applications such as, but by no means limited to, hobby robotic applications and radio-controlled models (cars, planes, boats, etc.). One example of a hobby servo is the Futaba S-148 available from Futaba Corporation of America located in Schaumburg, Ill.

### SUMMARY

An aspect of the disclosure relates to multi-rotation hobby servo motors. In one embodiment, a hobby servo motor comprises a rotatable output shaft, a feedback mechanism, and a control circuit. The feedback mechanism generates a feedback signal that is indicative of rotation of the rotatable output shaft, and the control circuit utilizes the feedback signal to generate a control signal for the rotatable output shaft. The feedback mechanism is optionally an encoder such as, but not limited to, a magnetic encoder, an optical encoder, a rotary encoder, or a linear encoder.

These and various other features and advantages that characterize the claimed embodiments will become apparent upon reading the following detailed description and upon reviewing the associated drawings.

### BRIEF DESCRIPTION OF THE DRAWINGS

FIG. 1-1 is a block diagram of a multi-rotation hobby servo motor.

FIG. 1-2 is a block diagram of a method of controlling a multi-rotation hobby servo motor.

FIG. 2-1 is a perspective view of a hobby servo motor.

FIG. 2-2 is a side view of the hobby servo motor.

FIG. 2-3 is a perspective view of the hobby servo motor showing an internal potentiometer and control circuit removed from the hobby servo housing.

FIG. 3-1 is a perspective view of a pan and tilt system.

FIG. 3-2 is an exploded view of a pan and tilt system.

FIG. 4 is a top down view of a kit that includes a multi-rotation hobby servo motor.

FIG. 5-1 is a perspective view of a hobby servo shaft attachment mechanism attached to a multi-rotation hobby servo motor.

FIG. 5-2 is a side view of the hobby servo shaft attachment mechanism of FIG. 5-1.

FIG. 6 is a perspective view of an apparatus for enhancing the operational performance of a multi-rotation hobby servo motor.

FIG. 7 is a perspective view of an apparatus for extending the rotational capacity of a multi-rotational hobby servo motor.

FIG. 8A is a front perspective view of an apparatus for extending the operational capacity of a multi-rotational hobby servo motor.

FIG. 8B is a back perspective view of the apparatus of FIG. 8A.

FIGS. 9A-9K are diagrammatic illustrations demonstrating alteration of a hobby servo motor.

FIG. 10 is a perspective view of an adapter for a multi-rotational hobby servo motor.

### DETAILED DESCRIPTION

Certain embodiments of this disclosure pertain to a hobby servo motor that supports a broad range of rotation (e.g., supports multiple complete rotations, as well as rotations below and beyond 360 degrees) yet does not require an external, multi-rotational potentiometer. Instead, everything is integrated into the hobby servo motor itself. In one embodiment, a multi-rotational feedback device is integrated into the hobby servo motor. For example, the device can be an encoder, such as but not limited to an optical encoder or a magnetic encoder, that supports sensing of rotation less than 360 degrees, more than 360 degrees and multi-turn rotation. In one embodiment, an encoder (e.g., optical or magnetic) or a similar device the same size or shape as the factory potentiometer is incorporated into a hobby servo in place of the regular factory potentiometer. Accordingly, one embodiment of the present invention pertains to substitution of a different category of feedback mechanism (e.g., optical or magnetic encoder) in place of the traditional factory hobby servo potentiometer. This eliminates the need for the external potentiometer configuration.

In one embodiment, the hobby servo motors in which an encoder is utilized instead of a potentiometer are hacked or otherwise configured for continuous rotation (e.g., rotation ranges less than and greater than 360 degrees, as well as multi-complete-turn rotation). For example, hobby servo manufacturers recently started offering servomotors with factory continuous rotation. However, these new servomotors are open-looped in that there is no positioning feedback. There is really no good way to hook an external potentiometer to these new servomotors, at least because there are resistors wired directly to the circuit board. Resistors, in a way, take the place of the external potentiometer. In one embodiment, an encoder is incorporated into this type of servo. Alternatively, a more traditional servo is hacked for continuous rotation and an encoder is functionally integrated into the motor instead of a potentiometer.

One skilled in the art will understand that there are no or few programmable servos in the hobby market that can be programmed over 360 degrees of rotation. Both digital and analog hobby servos, other than the above noted open-looped continuous rotation servos, are generally quite limited in terms of the degree of rotation and the related control. The internal potentiometers used today don't support an extended range of rotation.

It is also noted that potentiometers are often not as precise as encoders. It is conceivable that an encoder might be utilized within a hobby servo instead of a potentiometer simply for improved control resolution and not solely for supporting extended rotation. However, software (or firmware, etc.) that supports the servo encoder control for extended rotation may need to be different than software simply for supporting improved control resolution within a limited range of rotation. Accordingly, one embodiment of the present invention pertains to software configured to support an encoder (such as but not limited to a magnetic or optical encoder) that enables rotation in the extended ranges. Other embodiments pertain to new features incorporated into new hobby servo motor as described herein (e.g., a hobby servo motor with an internal encoder for functionally supporting proportional control relative to extended rotation and multiple complete rotations).

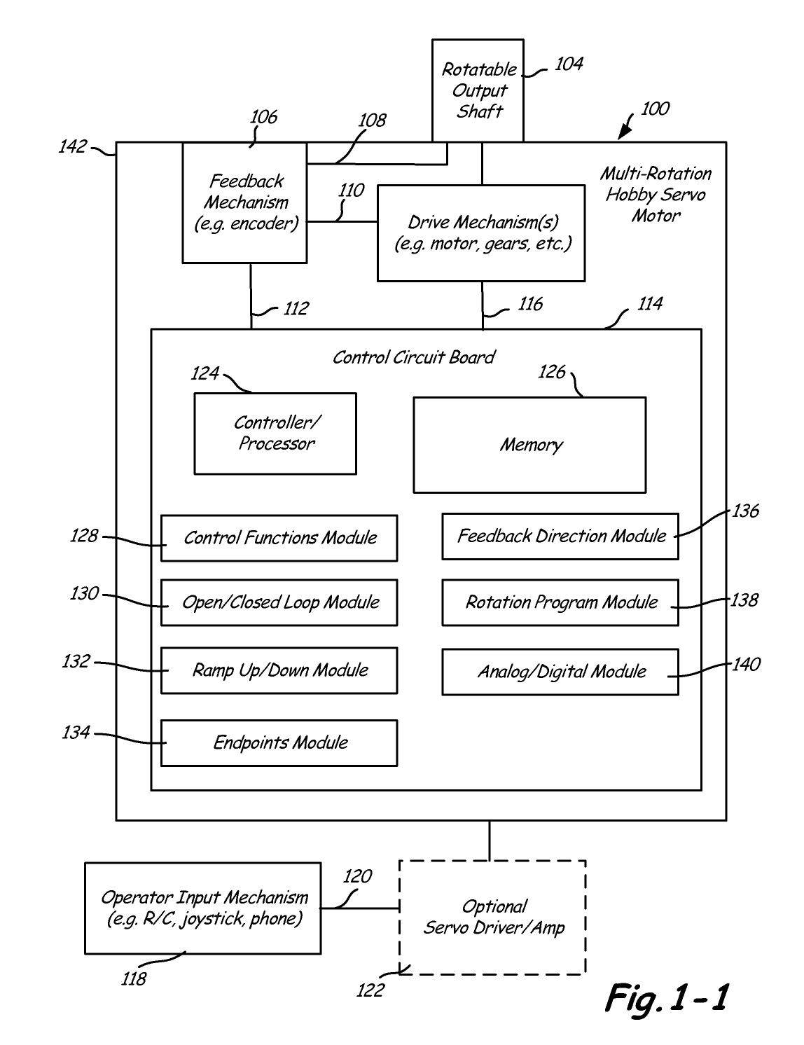

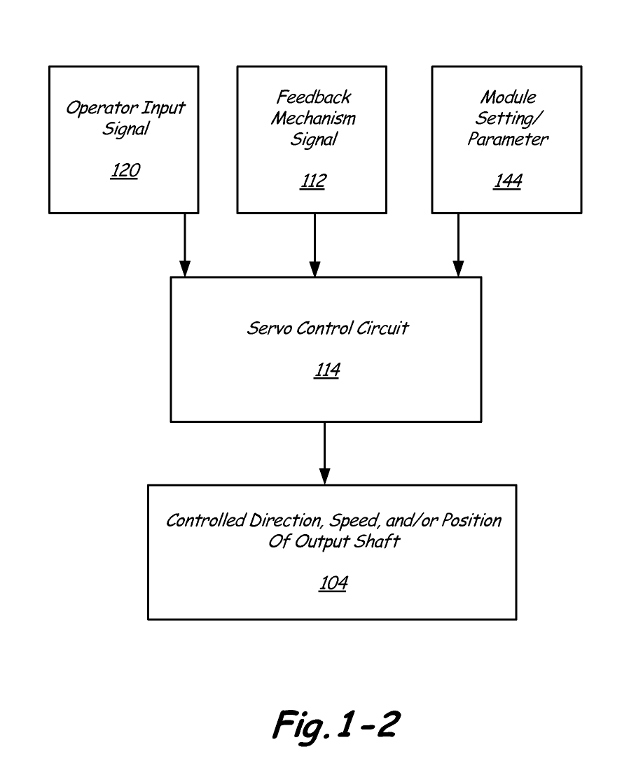

FIG. 1-1 is a schematic diagram of one embodiment of a multi-rotation hobby servo motor 100. The components of motor 100 are illustratively included within a case or housing 142. Servo 100 illustratively includes a drive mechanism(s) 102 that rotates a rotatable output shaft 104. Shaft 104 optionally has an outer splined surface having teeth that enable shaft 104 to functionally engage with other mechanisms such as, but not limited to a gear or horn. Drive mechanism(s) 102 optionally include any combination of electrical and mechanical devices that are used to rotate shaft 104. For example, drive mechanism(s) 102 may include motors, gears, sprockets, bands, chains, etc.

In an embodiment, multi-rotation hobby servo motor 100 includes a feedback mechanism 106. Feedback mechanism 106 illustratively includes an encoder such as, but not limited to a magnetic or optical encoder. Feedback mechanism 106 optionally receives feedback 108 from output shaft 104 and/or feedback 110 from drive mechanism(s) 102. Accordingly, feedback mechanism 106 is illustratively able to determine a position, direction, and/or speed of rotation of output shaft 104. Based on the feedback 108 and/or 110, feedback mechanism 106 generates a feedback signal 112 that is transmitted to a control circuit board 114. Control circuit board 114 utilizes the signal 112 to generate a control signal or command 116 that is sent to drive mechanism(s) 102 to control output shaft 104 (e.g. position, direction, and/or speed of output shaft 104).

In one embodiment, feedback mechanism 106 is a rotary encoder, also sometimes called a shaft encoder, that is an electro-mechanical device that converts the angular position or motion of output shaft 104 and/or a component of drive mechanism(s) 102 to an analog or digital code. The output of feedback mechanism 106 provides information about the motion of the shaft which is further processed into information such as speed, distance, RPM and position of output shaft 104.

In another embodiment, feedback mechanism 106 is a linear encoder that is a sensor, transducer or readhead paired with a scale that encodes position. The sensor reads the scale in order to convert the encoded position into an analog or digital signal, which can then be decoded into position by a digital readout (DRO) or motion controller. The encoder can be either incremental or absolute. Motion can be determined by change in position over time. Linear encoder technologies include optical, magnetic, inductive, capacitive and eddy current. Optical technologies include shadow, self imaging and interferometric.

The signal 116 generated by the control circuit board 114 is also optionally based on an input from an operator input mechanism 118. Operator input mechanism 118 illustratively includes a device that enables a user to input a command for controlling a position, direction, and/or speed of output shaft 104. Some examples of operator input mechanism 118 include, but are not limited to, a joystick, a remote control unit, a portable computing device, a smart phone, a tablet computer, a notebook computer, a netbook computer, a personal computer, a server, and any other suitable mechanical and/or electrical device. Based on the operator input, the operator input mechanism 118 generates a signal 120 that is sent to control circuit board 114 that is used to control output shaft 104. Furthermore, as is shown in FIG. 1-1, a servo driver or amplifier is optionally connected (wirelessly or wired) to operator input mechanism 118 that communicates signal 120 to control circuit board 114.

Control circuit board 114 illustratively includes a controller or processor 124 and memory 126. Controller 124 and memory 126 may be implemented as separate components or combined into one unit. Some examples of controller 124 include, but are not limited to, a microcontroller, a RISC processor, an ASIC processor, a system on a chip, and any other type of controller and/or processor. Some examples of memory 126 include solid state memory (e.g. flash, EEPROM, SRAM, DRAM, etc.), magnetic memory (e.g. hard disk drive), optical memory (e.g. CD-ROM, DVD), polymer-based memory, and any other type of memory. Additionally, control circuit board 114 may include a combination of different memory types.

Control circuit board 114 illustratively includes a number of modules utilized to implement various functions of the multi-rotation hobby servo motor 100. The modules are illustratively executed or performed using either the controller 124 and/or the memory 126. The modules may be implemented as software, firmware, computer executable instructions, and/or be hard wired (e.g. embedded) into controller 124.

In an embodiment, multi-rotation hobby servo motor 100 includes one or more of a control functions module 128, an open/closed loop module 130, a ramp up/ramp down module 132, an endpoints module 134, a feedback direction module 136, a rotation program module 138, and an analog/digital module 140.

Control functions module 128 illustratively optimizes the control functions of the hobby servo motor 100 to support extended and/or unlimited rotation (e.g. rotation less than or greater than 360 degrees, as well as multiple complete rotations).

Open/closed loop module 130 illustratively provides the ability to run motor 100 as a continuous rotation servo (e.g. open loop) or closed loop (e.g. utilized feedback mechanism 106). In one embodiment, there is a switch that enables selection of one or the other. In another embodiment, the switch is an electronic switch on the control circuit board 114. Alternatively, the switch is a mechanical button or physical switch on an exterior (e.g. on case/housing 142) of the motor 100. The switch is optionally a button, a switch, or software activated. Additionally, in an embodiment, software or firmware includes functionality for switching between open and closed loop.

Ramp up/ramp down module 132 provides an ability to ramp up and ramp down output shaft 104 once it gets close to its desired (e.g. set, programmed, etc.) position. Module 132 illustratively enables variable acceleration and/or deceleration that is adjustable based on a user preference or setting (e.g. a user configurable setting). In one embodiment, the adjustments are made within the software.

Endpoints module 134 illustratively provides an ability to physically/manually set a left endpoint, a right end point, and/or a neutral point for the output shaft 104. In an embodiment, a user can twist the output shaft 104 to where they want each point . . . and then press a button (e.g. on motor 100 or input mechanism 118) to set the point. A button is optionally a physical button on housing 142 of servo motor 100 or it might be a setting with in software. The software illustratively sets the points and behaves accordingly, but the user gets to choose those points by physically turning the output shaft 104 to where they want to points to be, and the user then pushes the aforementioned button that signals to the system (e.g. control circuit board 114) where the point is to be set.

Feedback direction module 136 illustratively provides an ability to control a direction (e.g. forward or reverse) of the feedback (e.g. signal 112). This functionality is optionally supported within the software. In an embodiment in which multiple servo motors 100 are used, a user can selectively set the feedback direction of each of the motors 100.

Rotation program module 138 illustratively provides an ability to program the amount of rotation of output shaft 104 in each given direction relative to neutral. A user can program the amount of rotation that you need . . . even degrees of rotation. For example, a user can program rotation less than and greater than 360 degrees . . . and even multiple rotations . . . or sub-portions of multiple rotations. In an embodiment, a user can program hobby servos beyond 360 degrees of rotation.

Analog/digital module 140 illustratively provides an ability to selectively run hobby servo motor 100 in either an analog mode or a digital mode. The mode can optionally be changed/set by a physical button or switch (e.g. on housing/case 142 or input mechanism 118) or through a software based user interface setting or actuable switch/button (e.g. on input mechanism 118).

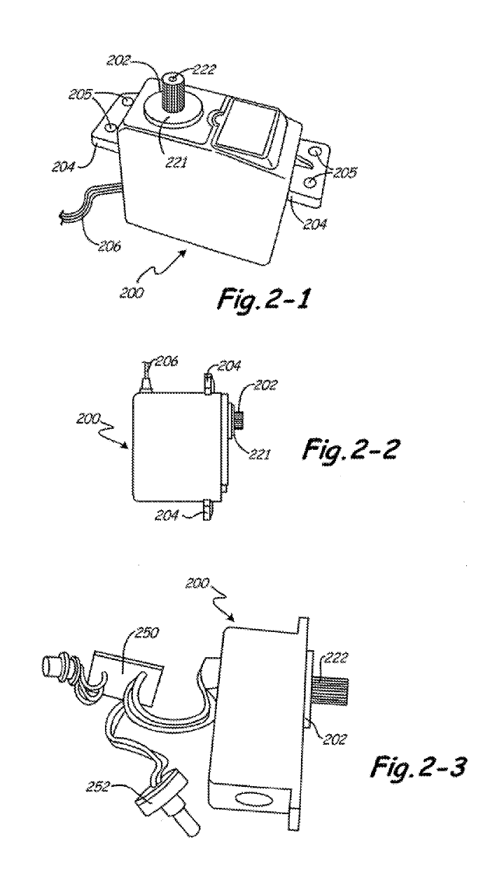

FIG. 1-2 is a block diagram of a method of controlling a multi-rotation hobby servo motor 100 (e.g. a position, direction, and/or speed of output shaft 104 in FIG. 1-1). The servo control circuit 114 illustratively receives an operator input signal 120, a feedback mechanism signal 112, and a signal or indication of a module setting and/or parameter 144 (e.g. from one or more of modules 124, 126, 128, 130, 132, 134, 136, 138, and/or 140 in FIG. 1-1). The control circuit 114 utilizes one or more of the inputs 120, 112, and 144 to generate a signal 116 that is used to control the position, direction, and/or speed of output shaft 104. It should be noted that input 144 may include an input/setting from one or more buttons or switches associated with motor 100 (e.g. an analog/digital switch, endpoints switch, rotation switch/button, etc.).

FIG. 2-1 is a perspective view of a hobby servo motor 200 and FIG. 2-2 is a side view of hobby servo motor 200. In an embodiment, servo motor 200 includes a feedback mechanism (e.g. feedback 106 in FIG. 1-1) and is a motor such as motor 100 in FIG. 1-1. Servo 200 includes attachment flanges 204. Flanges 204 optionally include apertures 205 formed therein for receiving an attachment mechanism (e.g., a screw, bolt, etc). The attachment mechanism is illustratively utilized to secure servo 200 within an operative environment. Servo 200 also includes an electrical connection 206 that enables the servo to receive electrical power and/or control signals.

Servo 200 includes a rotatable output shaft 202 also known as a servo spline or a servo splined output shaft. Shaft 202 optionally has an outer perimeter or periphery that has splines or teeth. It is common for shaft 202 to have a 23, 24 or 25 tooth configuration.

Output shaft 202 is positioned to specific angular positions in accordance with a coded input signal received by the servo. It is common that a particular angular position will be maintained as long as a corresponding coded signal exists on an input line. If the coded signal changes, the angular position of the servo output shaft 202 will change accordingly.

In an embodiment, output shaft 202 includes a threaded orifice 222. Threaded orifice 222 extends into splined output shaft 202 from its distal end. As will be described later, orifice 222 is illustratively used to secure an item such as a gear, horn, or other attachment mechanism to shaft 202. Servo 200 further includes a planar or relatively planar surface 221 that surrounds shaft 202. In accordance with one aspect of the present disclosure, gears, horn, and attachment mechanisms that are attached to, rotatably coupled to, or functionally engaged to shaft 202 also include a planar or relatively planar surface. In such an embodiment, a surface of the item being attached and surface 221 are engaged to one another in a relatively flush relationship.

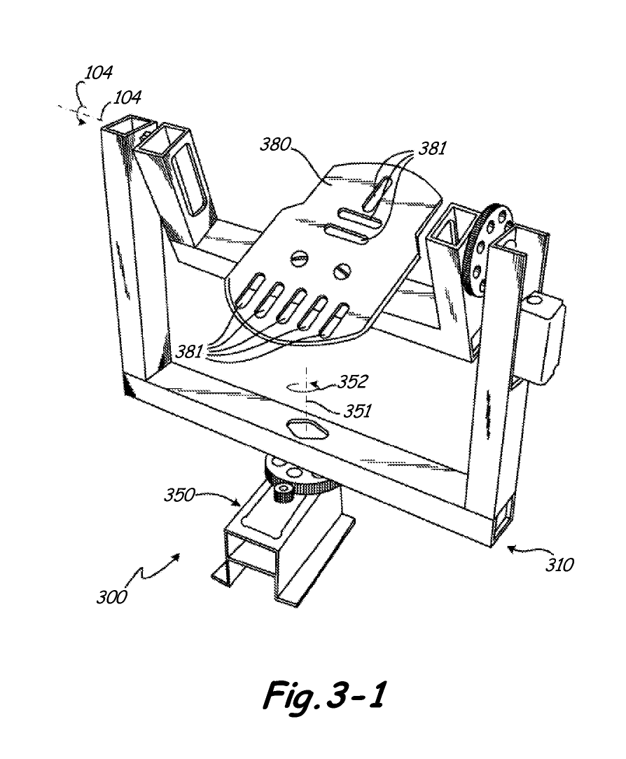

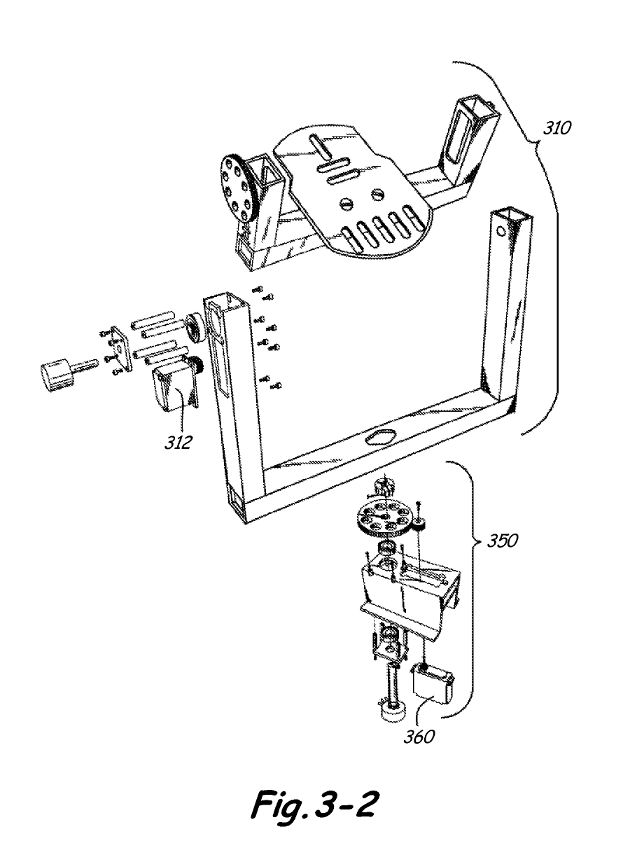

FIG. 2-3 is a perspective view of hobby servo motor 200 showing an internal potentiometer 252 and control circuit 250 removed from the hobby servo housing or casing. Control circuit or circuits such as circuit 250 and an internal potentiometer such as potentiometer 252 are commonly included within the housing or casing of a hobby servo motor. The control circuitry and potentiometer are functionally connected to the hobby servo motor rotatable output shaft. Through the potentiometer (e.g., a variable resistor), the control circuitry is able to monitor the angle of the output shaft. If the shaft is at the correct angle, the motor actuates no further changes. f the shaft is not at the correct angle, the motor is actuated in an appropriate direction until the angle is correct. In an embodiment, internal potentiometer 252 is replaced with a feedback mechanism (e.g. mechanism 106 in FIG. 1-1).

Rotation of a servo output shaft such as shaft 202 is typically limited to around 180 degrees. In most cases, rotation is limited at least because of an internal mechanical stop. It is also common that servo output shaft 202 is capable of producing a relatively limited amount of torque power. The torque and rotational limitations of a hobby servo are adequate for many applications; however, some applications require a servo having torque power and/or a rotational capacity that is beyond the capability of a typical hobby servo. Increased torque power and/or rotational capacity enable greater mechanical flexibility.

In accordance with one embodiment of the present disclosure, hobby servo motors such as servo 200 are internally modified to enable a range of output shaft rotation that is greater than its “off-the-shelf” capability. For example, in accordance with one embodiment, an internal mechanical stopping mechanism, which prevents rotation past a predetermined angle, is removed from hobby servo motor to enable for continuous rotation in either direction. As a result of the modification, the rotatable output shaft of a hacked or modified servo is able to rotate beyond the range of rotation prior to the modification.

Following modification of servo 200 (e.g. by insertion of feedback mechanism 106), limitations inherent to the internal potentiometer make it a poor choice for subsequent control functionality. As previously mentioned, in a normal servo operating configuration, the servo motor rotates the servo output shaft corresponding to the coded signal received by the servo. The output shaft is rotated until the signal from the internal potentiometer of the servo, which corresponds to the angular position of the servo output shaft, matches the coded signal received by the servo. Most hobby servos contain internal potentiometers such as potentiometer 252 shown in FIG. 2-3 that are physically limited to monitoring a limited range of angles (e.g., often less than 200 degrees). Therefore, when a servo 200 is modified for extended rotation, the internal potentiometer is not the best control component for applications that require the servo shaft to rotate beyond the typical rotation limits in order to provide improved rotational capacity. The internal potentiometer is not likely to support control of a range of rotation that is even equivalent to the original rotational range of the servo output shaft.

In accordance with one aspect of the present disclosure, the internal potentiometer is disconnected and an external/auxiliary potentiometer is inserted into the control scheme to facilitate proportional control of the servo splined output shaft. Alternatively or in addition, the internal potentiometer is optionally replaced with a feedback mechanism (e.g. mechanism 106 in FIG. 1-1). In an embodiment, servo 200 utilizes the coded input signal and the signal from an external potentiometer to rotate and position the output shaft. A particular external potentiometer having any of a variety of control characteristics can be selected and implemented based on the requirements of a given application. Therefore, a potentiometer with a rotational range of substantially less than or greater than 180 degrees can be selected and implemented as desired.

FIG. 3-1 is a perspective view of a pan and tilt system 300 that illustratively utilizes multi-rotation hobby servo motors. System 300 includes a camera mounting plate 380. Plate 380 optionally includes slots or apertures 381. Apertures 381 are used to attach and position various types of cameras to pan and tilt system 300. Embodiments of camera mounting plate 380 illustratively include features such as, but not limited to, clamps, hooks, bolts, and apertures/slots of all sizes and shapes that are used to attach or secure a camera to system 300. Alternatively, in an embodiment, pan and tilt system 300 does not include a mounting plate 380 and a camera is directly attached to or secured to the bar shown in FIG. 3-1 as supporting plate 380.

System 300 includes a tilt system 310 and a pan system 350. Tilt system 310 includes a tilt axis of rotation 301. Tilt system 310 includes components that are able to rotate an attached camera about axis 301 in the direction shown by arrow 302 and in the direction opposite of that shown by arrow 202. Pan system 350 includes a pan axis of rotation 351. Pan system 350 includes components that are able to rotate an attached camera about axis 351 in the direction shown by arrow 352 and in the direction opposite of that shown by arrow 352.

FIG. 3-2 is an exploded view of pan and tilt system 300. Bracket 310 represents illustrative components of a tilt system, and bracket 350 represents illustrative components of a pan system. FIG. 3-2 shows that the tilt system 310 includes a tilt servo 312 and that pan system 350 includes a pan servo 360. Tilt servo 312 and pan servo 360 are, in certain embodiments, multi-rotation hobby servo motors (e.g. with a feedback mechanism 106 in FIG. 1-1).

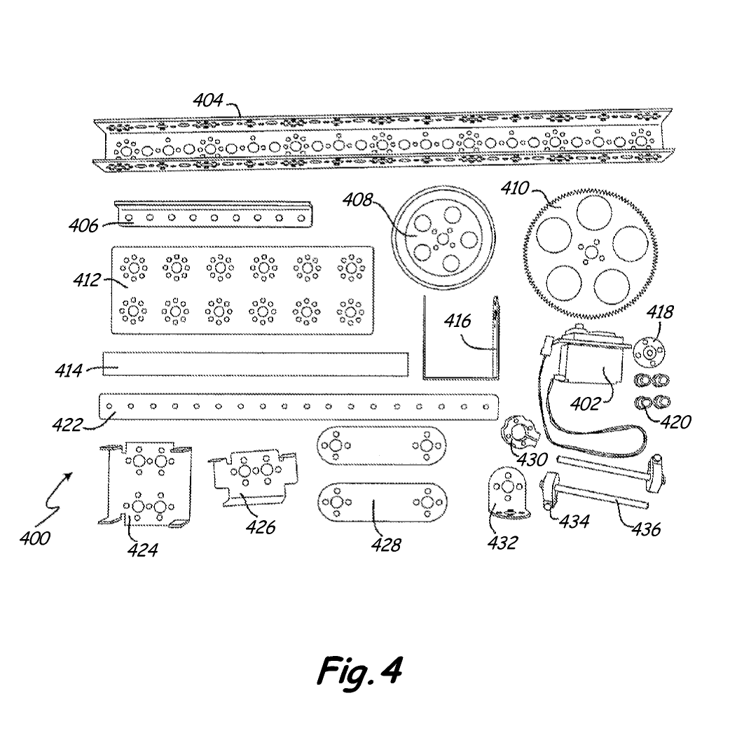

FIG. 4 is a top down view of a kit 400 that optionally includes one or more multi-rotation hobby servo motors 402. In one embodiment, the components shown and described herein are sold together in a kit. Embodiments of kits include any combination of components. Further, the components are illustratively sold in kits that include more than one unit of a given component. It is also contemplated that any of the components are sold individually, for example, to supplement a previously purchased collection of the components.

Kit 400 illustratively includes one or more multi-rotation hobby servo motors 402 and a variety of structural and mechanical components. Some examples of components that may be included within kit 400 include multi-rotation hobby servo motor 402, channel piece 404, angle bar 406, wheels 408, gear 410, flat plate 412, tubing 414, bracket 416, horn 418, bushings 420, flat bar 422, dual servo mounting bracket 424, single servo mounting bracket 426, flat brackets 428, clamps 430, angled bracket 432, hub 434, and shaft 436.

The components in kit 400 include features that allow for the components to be connected to or attached to each other, allowing for a variety of different assemblies of components. Those skilled in the art will appreciate that kit 400 is but one example of a kit. There, of course, are many variations. It is also to be understood that individual components, including additional instances of the illustrated components and/or components other than those illustrated are optionally added to embodiments of kits. Of course, smaller or larger quantities than the illustrated quantities are also included in embodiments.

In certain embodiments of kits, some standard, well-known components are included. Some of these are illustratively off-the-shelf type components such as screws, bolts, and washers. However, many of the components shown in FIG. 4 are unique and are described in detail below.

In one embodiment, some or all of the components in a kit are made from one or more metals such as, but not limited to, aluminum or stainless steel. In another embodiment, one or more components or one or more parts of a component are made from non-metal materials. In yet another embodiment, a combination of metal and non-metal materials is used.

As will become apparent, many of the parts incorporate a modular attachment scheme. In particular, the larger, more structural components incorporate a through hole scheme with carefully selected dimensions and placement such that there is a consistency from one part to another. This enables components and hardware (e.g. a bushing, a shaft, etc.) to be inserted/engaged consistently from one part to the next. In other words, the connection scheme is very modular. Thus, there is a large number of different combinations in which the various parts can be assembled. As additional pieces are added to a kit, the number of possible combinations increases.

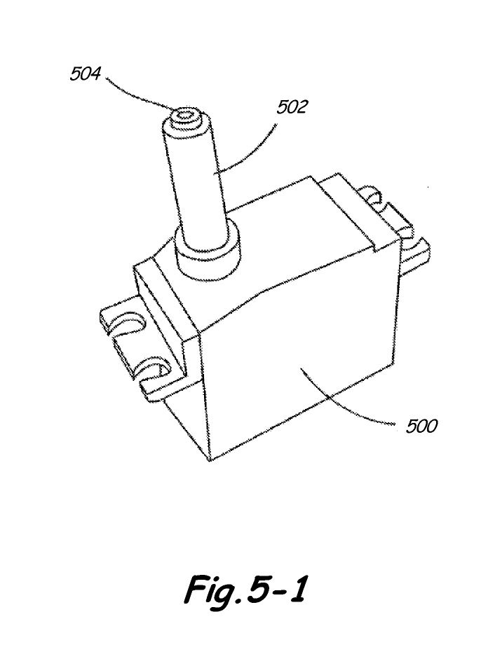

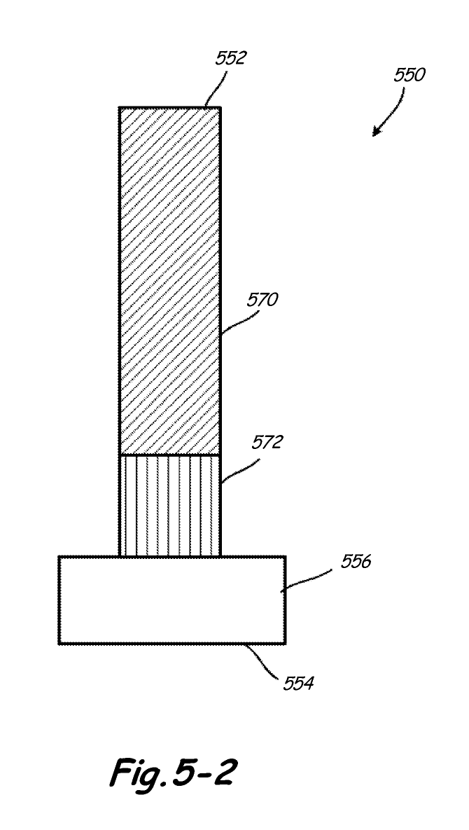

FIG. 5-1 is a perspective view of an embodiment of a hobby servo shaft attachment mechanism 502 (hereinafter “HSAM 502”) that is optionally functionally connected to a multi-rotation hobby servo motor 500 such that rotation of the output shaft of motor 500 is translated to HSAM 502. In an embodiment, HSAM 502 includes an attachment surface that provides a cylindrical surface that receives attachment items that include a bore. The diameter of the cylindrical surface of HSAM 502 is manufactured to any desired value. For example, the bore is made to accommodate ¼″ or ⅜″ bored attachment items. Attachment surface need not be a cylindrical area. Embodiments of attachment surface include every shape and size.

In an embodiment, HSAM 502 is securely and functionally engaged to output shaft 104 (in FIG. 1-1), and HSAM 502 bottom surfaces are flushly engaged with circular planar surface of the servo. In an embodiment, HSAM 502 is securely attached to hobby servo 500 using screw 504. In other embodiments, attachment mechanisms other than screws are used. The attachment of HSAM 502 to hobby servo 500 provides many useful features. HSAM 502 provides enhanced performance such as increased strength and durability. HSAM 502 supports greater side-loads on the servo than the servo could support alone. HSAM 502 also allows for items that cannot be directly attached to a hobby servo to be indirectly attached.

FIG. 5-2 is a side view of another embodiment of a hobby servo attachment mechanism (HSAM) 550 that may be attached/connected to a multi-rotation hobby servo motor. HSAM 550 also illustratively includes a top surface 552, a bottom surface 554, and an output shaft attachment housing 556. Additionally, HSAM 550 optionally includes two or more different surfaces along the rotatable shaft. In the embodiment shown in FIG. 5-2, HSAM 550 includes a first threaded surface 570 and a second threaded surface 572. First threaded surface 570 may for instance include screw, worm screw, gear, or any other type of threading. Second surface 570 may also illustratively include screw, gear, or any other type of threading. In one embodiment, first and second threaded surfaces 570 and 572 include different types of threading (e.g. one includes screw threading and the other gear threading), or alternatively, both surfaces 570 and 572 may include the same type of threading. In another embodiment, one or more of surfaces 570 and 572 may instead include a non-textured surface (e.g. a smooth outer surface). Additionally, embodiments of HSAM 550 are not limited to only including two surfaces along the rotatable shaft. Embodiments of HSAM 550 optionally include any number of surfaces along the rotatable shaft. For instance, HSAM 550 may include three different surfaces instead of the two shown in FIG. 5-2 with one surface having screw threading, one gear threading, and the other surface being smooth.

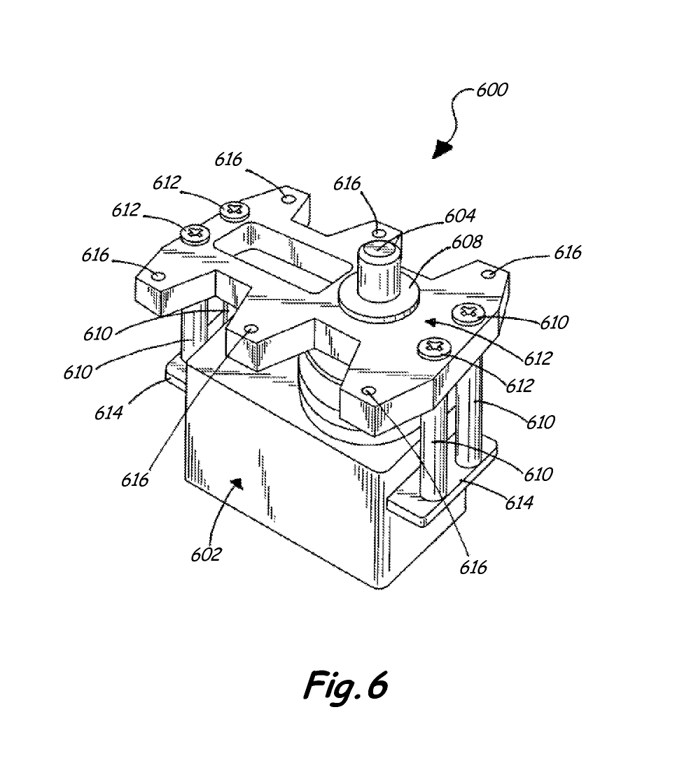

FIG. 6 is a perspective side view of an apparatus 600 for enhancing the mechanical capacity of a multi-rotation hobby servo motor 602. Apparatus 600 comprises a frame 606 mounted to servo 602 using spacers 610 and flanges 614. In accordance with one aspect of the present invention, spacers 610 are secured such that they form a substantially rigid connection between frame 606 and servo 602. In this manner, frame 606 has relatively limited movement with respect to servo 602. The distal ends of spacers 610 are further connected to frame 606 by attachment mechanisms 612 inserted through frame apertures.

Auxiliary shaft 604 is rotatably engaged to servo 602 and is supported by frame 606 through the use of bushing 608. The support of auxiliary shaft 604 by frame 606, coupled with the substantially rigid connection between servo 602 and frame 606, allows for the substantial absorption of forces applied perpendicular to auxiliary shaft 604. As a result, auxiliary shaft 604 may withstand greater forces before damage or breakage occurs.

In accordance with another aspect of the present invention, frame 606 comprises mounting apertures 616 for securing apparatus 600 in an operating environment. In one embodiment, attachment mechanisms are inserted through apertures 616 and fastened to corresponding apertures in the operating environment. Attachment mechanisms may include screws, bolts, clips, nails, rivets, or any other means for securing apparatus 600. It is important to note that other attachment schemes may be utilized to secure apparatus 600 without departing from the scope of the present invention.

FIG. 7 is a perspective view of an apparatus 700 that is illustratively utilized with a multi-rotation hobby servo motor 702. Apparatus 700 has a frame 704 includes apertures 730 for receiving an attachment mechanism (e.g., a screw, bolt, etc) for attaching apparatus 700 within an operational environment. For example, the frame could be secured in a location proximate to a target for mechanical actuation. The frame member includes a first aperture 732 for receiving and supporting servo 702. A second aperture 722 is also formed in the frame and is configured to receive and support auxiliary shaft 742.

Attachment apertures 740 are formed in the frame as necessary to accommodate attachment of servo 702 to the frame (e.g., attachment flanges associated with the servo have apertures that are lined up with the attachment apertures 740 within the frame . . . and an attachment mechanism is slid through the aligned apertures to secure the servo to the frame).

Frame 704 includes a first panel portion 734 that is displaced from but connected to a second panel portion 736. A displacement mechanism 738 is positioned between panels 734 and 736. In fact, several displacement portions 738 are utilized to space and support the panel portions relative to one another. Each displacement mechanism 738 is illustratively attached to the first and second panel portions. For example, an attachment mechanism (e.g., a screw, an adhesive, etc) is utilized to secure the displacement mechanisms 738 between the panel portions. In one embodiment, a screw is inserted through an aperture in a panel portion and into the displacement portion 738. The screw can extend all the way through the displacement portion 738 and through a corresponding aperture formed in the opposite panel portion, wherein a bolt is then utilized to secure the panel portions to the displacement mechanism. Alternatively, a single screw can be inserted through each end of the displacement mechanism through an aperture formed in the panel portion such that the screws engage and secure themselves to the inside of the displacement portion thereby securing the panel portions to the displacement portion.

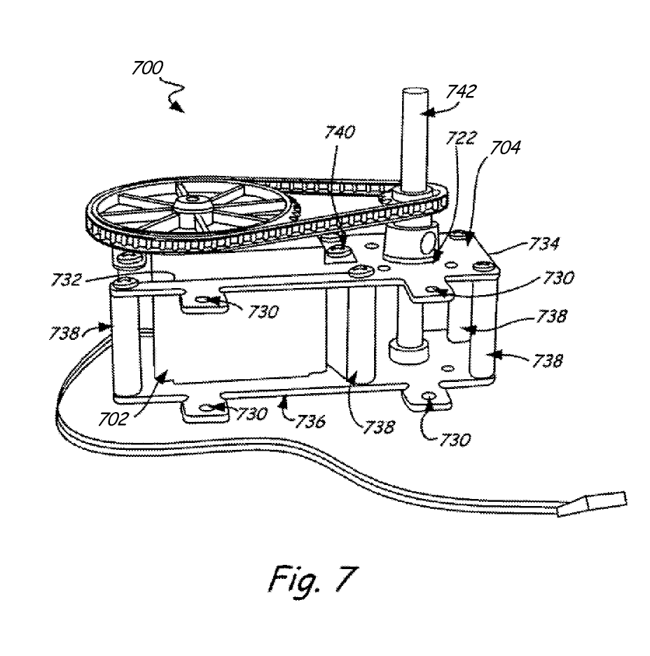

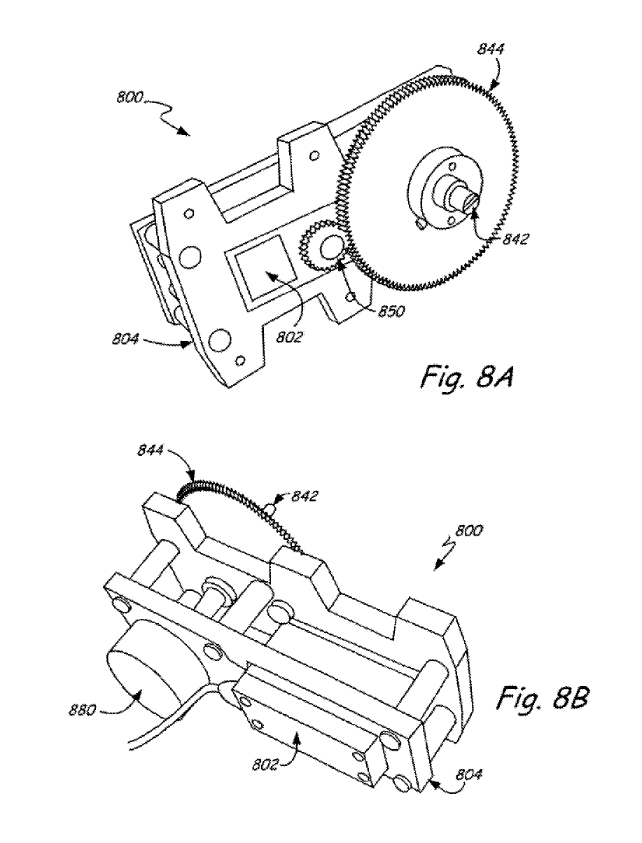

FIGS. 8A and 8B, in accordance with one aspect of the present invention, are front and back views, respectively, of a different apparatus 800 for extending the operational capacity of a multi-rotation hobby servo motor 802. Apparatus 800 is similar in many aspects to embodiments previously illustrated and described herein. Hobby servo 802 and auxiliary shaft 842 are mounted within frame 804. Auxiliary gear 844 is attached to auxiliary shaft 842 and is rotatably coupled to servo motor gear 850. For example, means such as a directed engagement or a chain, or any other means may be used to translate rotation from the servo output shaft to auxiliary gear 844 and shaft 842. In accordance with the illustrated embodiment, apparatus 800 is configured in a torque enhancement configuration (an enhanced rotation configuration may alternatively be implemented). In the illustrated configuration, gear 850 has a diameter much less than the diameter of auxiliary gear 844. As a result, the torque capacity associated with auxiliary shaft 842 will be greater than the torque capacity of the servo motor gear 850. The expanded torque capacity associated with shaft 842 can be taken advantage of to actuate increased mechanical loads. For example, an item can be attached to auxiliary shaft 842 (or to gear 844) and utilized to mechanically take advantage of the expanded torque capacity.

In accordance with another aspect of the present invention, hobby servo 802 is internally modified to enable a range of output shaft rotation that is greater than its “off-the-shelf” capability. For example, in accordance with one embodiment, an internal mechanical stopping mechanism, which prevents rotation past a predetermined angle, is removed from hobby servo 802 to enable for continuous rotation in either direction. As a result of the modification, servo 802 can rotate auxiliary gear 844 beyond the range of rotation attributed to the gear prior to the servo modification.

Following modification of servo 802, limitations inherent to the internal potentiometer make it a poor choice for subsequent control functionality. As previously mentioned, in a normal servo operating configuration, the servo motor rotates the servo output shaft corresponding to the coded signal received by the servo. The output shaft is rotated until the signal from the internal potentiometer of the servo, which corresponds to the angular position of the servo output shaft, matches the coded signal received by the servo. Most hobby servos contain internal potentiometers that are physically limited to monitoring a limited range of angles (e.g., often less than 200 degrees). Therefore, when apparatus 800 is configured in the illustrated enhanced torque configuration and incorporates a servo 802 modified for extended rotation, the internal potentiometer is not the best control component for applications that require the servo shaft to rotate beyond the typical rotation limits in order to provide shaft 842 with an improved rotational capacity. The internal potentiometer is not likely to support control of a range of rotation for shaft 842 that is even equivalent to the original rotational range of the servo output shaft. Therefore, in accordance with one aspect of the present invention, the internal potentiometer is disconnected and an auxiliary potentiometer 880 is asserted into the control scheme. Potentiometer 880 is functionally connected to shaft 842 and facilitates the proportional control thereof. In another embodiment, instead of using a potentiometer 880, a feedback mechanism (e.g. mechanism 106 in FIG. 1-1) in inserted into the control loop and is utilized to control the position of the servo output shaft.

Some applications require increased (enhanced) torque while still demanding the same, or in some cases greater, rotational capacity. Therefore, in accordance with one aspect of the present invention, the external potentiometer 880 is attached to auxiliary shaft 842 and is utilized to control the rotation of auxiliary shaft 842. As a result, servo 802 utilizes the coded input signal and the signal from external potentiometer 880 (and/or the feedback mechanism) to rotate and position auxiliary shaft 842. A particular external potentiometer 880 having any of a variety of control characteristics can be selected and implemented based on the requirements of a given application. Therefore, a potentiometer with a rotational range of substantially less than or greater than 180 degrees can be selected and implemented as desired.

In accordance with one embodiment, apparatus 800 is configured in an extended rotation configuration. In this configuration, as previously mentioned, servo gear 850 has a diameter substantially greater than auxiliary gear 844. Further, in accordance with this embodiment, external potentiometer 880 (and/or feedback mechanism) is configured to provide rotational and/or position control over the extended range of rotation of auxiliary shaft 842.

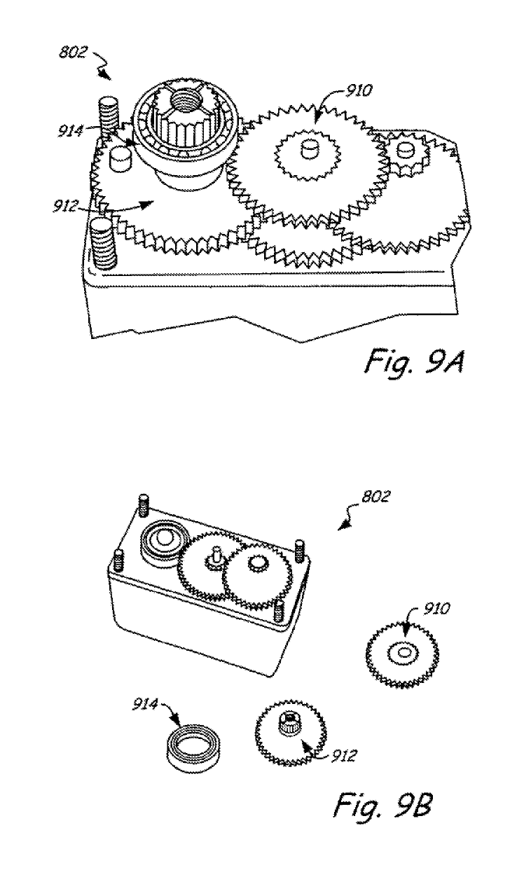

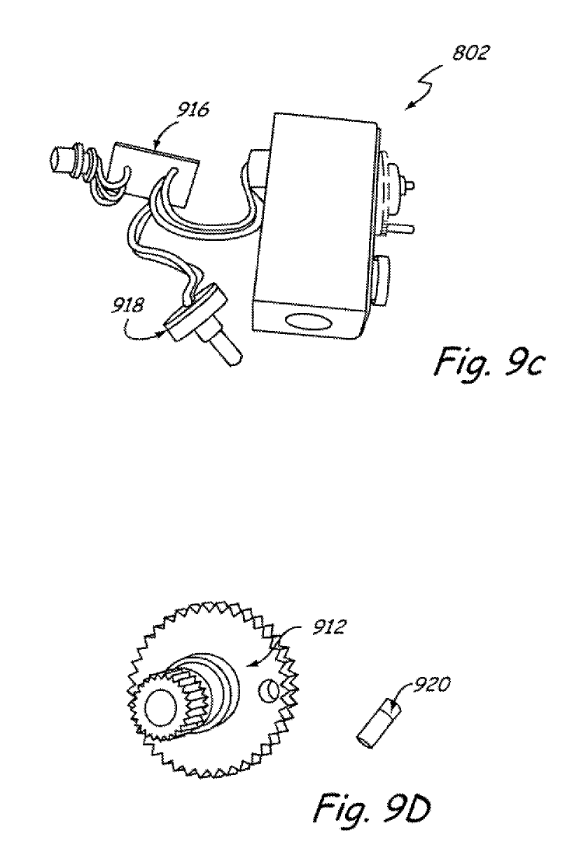

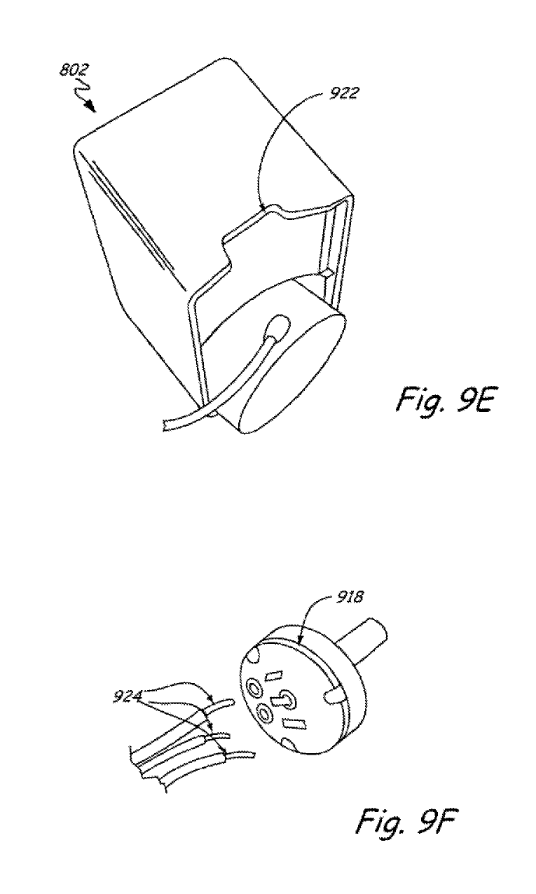

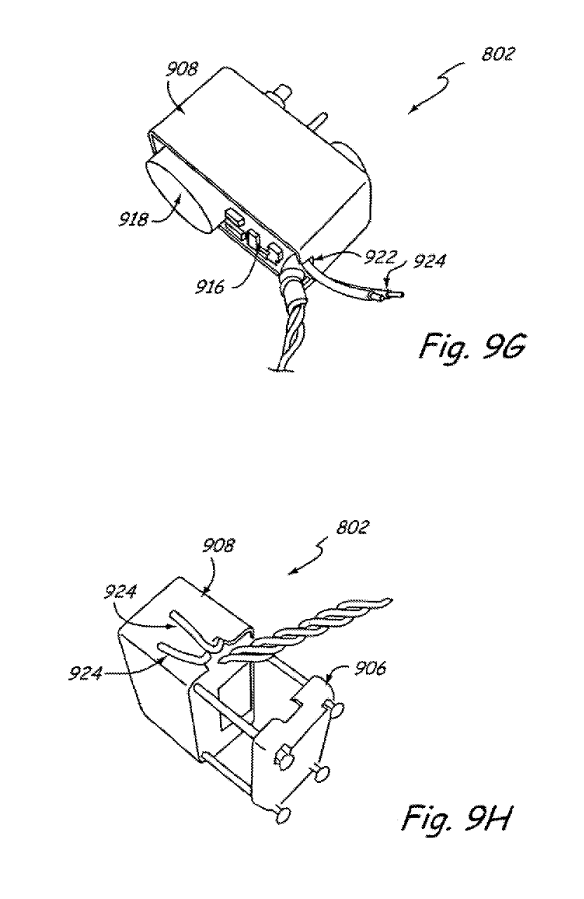

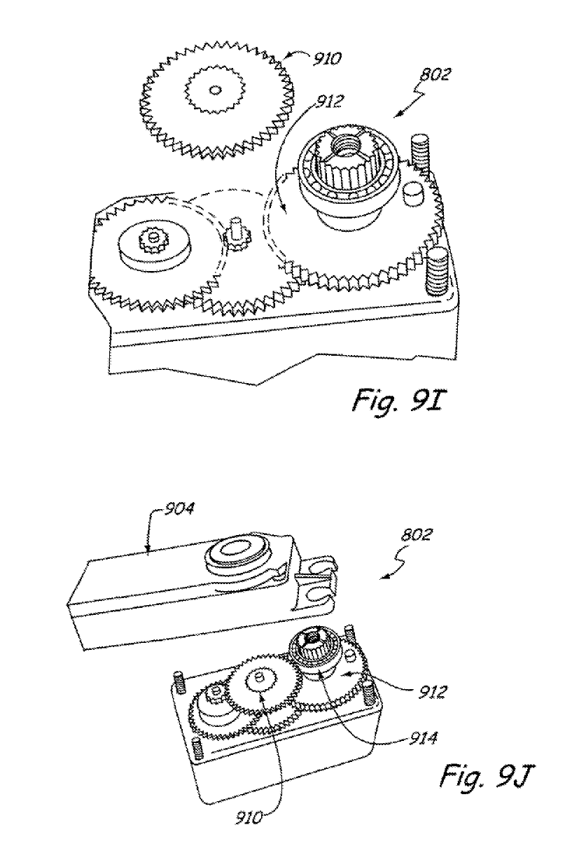

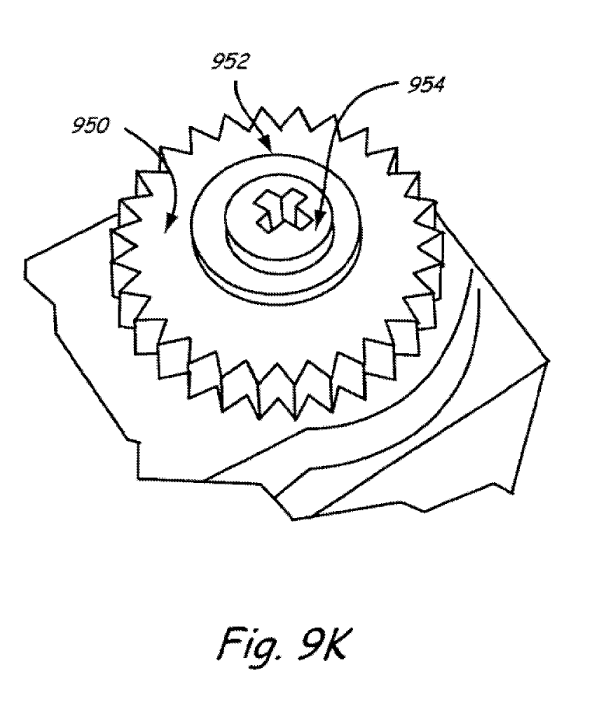

In accordance with one aspect of the present invention, FIGS. 9A-9K are diagrammatic illustrations demonstrating alteration of a hobby servo including removal of rotation impediments and disconnection of the internal potentiometer. The internal potentiometer is illustratively replaced with a feedback mechanism (e.g. a magnetic or optical encoder as described above). While many types and brands of hobby servos can be modified in a manner similar to the processes described herein, FIGS. 9A-9K are directed to the removal of mechanical stops from a Hitec HS-645MG hobby servo available from Hitec RCD USA, Inc. located in Poway, Calif.

In accordance with FIG. 9A, screws are removed from the bottom of the servo 802 and the top gear case (not pictured) is removed to expose the drive gears. The second to last drive gear 910 is removed first, followed by the main spline (gear with shaft) gear 912 as illustrated in FIG. 9B. Further, the bushing or bearing 914 is removed from the spline gear 912 (also as pictured in FIG. 9B). Not all servos have a bushing or bearing. In some cases, the outer gear case cover is configured to serve as a bushing. The bottom case (not pictured) is removed from the servo 802 and the electronics 916 and the potentiometer 918 are removed as illustrated in FIG. 9C. With the spline gear 912 out, pliers are used to remove the small pin stop 920 as shown in FIG. 9D (care must be exercised as to not damage the teeth on the gear). A utility knife is used to trim the case (make a groove 922) as illustrated in FIG. 9E to allow for extra wires that will be required to enter into the case when an auxiliary potentiometer is subsequently installed.

Wires 924 are disconnected from the internal potentiometer 918 using a soldering iron, while making note of the position of each colored wire 924 as different servos incorporate different colors and configurations (i.e. white=left, yellow=center, red=right) (shown in FIG. 9F). The electronics 916 and potentiometer 918 (and/or feedback mechanisms) are put back in the case 908, illustrated in FIG. 9G, with the potentiometer wires 924 running through the groove 922 (created by the step shown in FIG. 9E). The bottom case 906 is replaced to cover the electronics 916 (FIG. 9H) and the gears are reassembled back in place (FIG. 9I). The bearing or bushing 914 is placed back on the main spline gear 912 and the top gear case 904 is placed back on the servo (FIG. 9J). The screws are replaced in the bottom of the servo and the pinion gear 950 is mounted onto the servo output shaft using a washer 952 and servo horn screw 954 (FIG. 9K). Pinion gear 950 is functionally similar to servo output gear 850 referenced to apparatus 800 in FIG. 8.

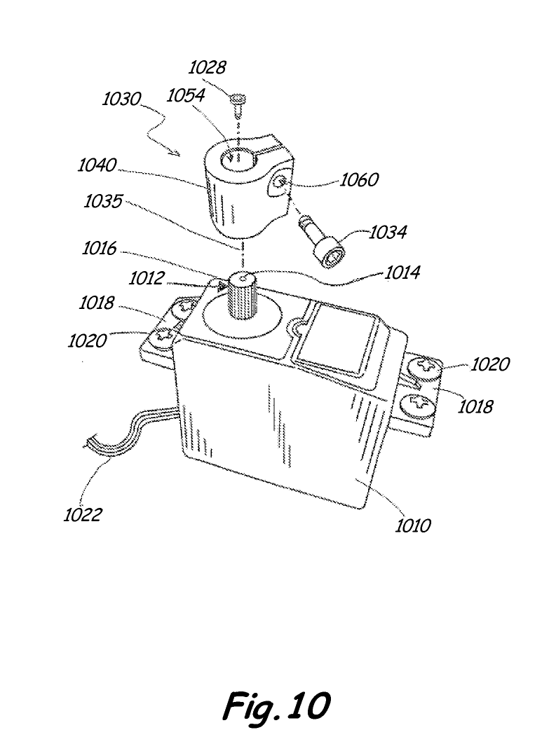

FIG. 10 illustrates an adapter 1030 that is illustratively attached to a multi-rotation hobby servo motor 1010. Servo motor 1010 has a rotatable splined output shaft 1012. Servo motor 1010 includes a pair of flanges 1018 for mounting servo motor 1010 in an operating environment. Flanges 1018 are adapted to receive mounting screws 1020.

Electrical cable 1022 is attached to the servo motor 1010 to provide electrical power and/or electrical signals to cause the output shaft 1012 to rotate in a counter-clockwise or clockwise direction. Servo motor 1010 can be any type of servo motor including a hobby servo motor and is not limited in terms of its style, capacity, motor speed, or load carrying capability.

An output shaft adapter assembly 1030 is configured to engage output shaft 1012 of servo motor 1010. Output shaft adapter assembly 1030 is further configured to accept and be engaged with an auxiliary shaft. Splined output shaft 1012 and an auxiliary shaft are coupled along a longitudinal axis. In one embodiment, splined output shaft 1012 has approximately 23 to 25 teeth. However, output shaft 1012 can have any number of teeth. Output shaft 1012 has a threaded orifice 1014 that extends into the splined output shaft 1012 from a distal end 1016 of the splined output shaft 1012.

The output shaft adapter assembly 1030 includes an adapter body 1040. In one example, adapter body 1040 is formed from aluminum. However, body 1040 can be made of any suitable material including, but not limited to, other metals, polymers, composite materials and so forth. Adapter body 1040 will be described in more detail below. The output shaft adapter assembly 1030 also includes a threaded fastener 1028 that is configured to engage the threaded orifice 1014 to secure adapter body 1040 to splined output shaft 1012.

As illustrated in FIG. 10, threaded fastener 1028 is inserted through an aperture 1054 formed in assembly 1030. Threaded fastener 1028 engages a portion of assembly 1030 and threaded orifice 1014 in output shaft 1012, thereby securing assembly 1030 to the output shaft.

In one example, assembly 1030 is engaged to hobby servo output shaft 1012 (e.g., such that assembly 1030 rotates with output shaft 1012).

It should be noted that embodiments of the present disclosure can include any combination of one or more of the features described above or shown in the figures.

Finally, it is to be understood that even though numerous characteristics and advantages of various embodiments have been set forth in the foregoing description, together with details of the structure and function of various embodiments, this detailed description is illustrative only, and changes may be made in detail, especially in matters of structure and arrangements of parts within the principles of the present disclosure to the full extent indicated by the broad general meaning of the terms in which the appended claims are expressed. In addition, although the embodiments described herein are directed to multi-rotation hobby servo motors, it will be appreciated by those skilled in the art that the teachings of the disclosure can be applied to other types of systems, without departing from the scope and spirit of the disclosure.

What is claimed is:

1. A hobby servo motor comprising:
a rotatable output shaft;
an encoder that generates a feedback signal indicative of rotation of the rotatable output shaft; and
a control circuit that utilizes the feedback signal to generate a control signal for the rotatable output shaft.

2. The hobby servo motor of claim 1, wherein the encoder comprises a magnetic encoder.

3. The hobby servo motor of claim 1, wherein the encoder comprises an optical encoder.

4. The hobby servo motor of claim 1, wherein the encoder comprises a rotary encoder.

5. The hobby servo motor of claim 1, wherein the encoder comprises a linear encoder.

6. The hobby servo motor of claim 1, wherein the encoder comprises a digital encoder.

7. A hobby servo motor comprising:
a feedback mechanism that generates a feedback signal indicative of rotation of a rotatable output shaft;
one or more modules for extending functionality of the hobby servo motor; and
a control circuit that utilizes the feedback signal and signals from the one or more modules to generate a control signal for the rotatable output shaft.

8. The hobby servo motor of claim 7, wherein the one or more modules comprises a control functions module that optimizes control functions of the hobby servo motor to support extended and/or unlimited rotation of the rotatable output shaft.

9. The hobby servo motor of claim 7, wherein the one or more modules comprises an open/closed loop module that provides an ability to run the hobby servo motor in either an open loop mode or in a closed loop mode.

10. The hobby servo motor of claim 7, wherein the one or more modules comprises a ramp up/ram down module that provides an ability to control acceleration and deceleration of the rotatable output shaft once the rotatable output shaft approaches a set position.

11. The hobby servo motor of claim 7, wherein the one or more modules comprises an endpoints module that provides an ability to set a left endpoint, a right endpoint, and a neutral point of the rotatable output shaft.

12. The hobby servo motor of claim 7, wherein the one or more modules comprises a feedback direction module that provides an ability to control a direction of the feedback signal.

13. The hobby servo motor of claim 7, wherein the one or more modules comprises a rotation program module that provides an ability to program an amount of rotation of the rotatable output shaft in each direction relative to neutral.

14. The hobby servo motor of claim 7, wherein the one or more modules comprises an analog/digital module that provides an ability to selectively run the hobby servo motor in either an analog mode or a digital mode.

15. A method of controlling an output shaft of a hobby servo motor comprising:
receiving a feedback signal indicative of rotation of the output shaft;
receiving a setting or parameter from one or more modules for providing extended functionality;
receiving an operator input signal; and
utilizing a control circuit to generate a control signal for the output shaft based at least in part on the feedback signal, the setting or parameter, and the operator input signal.

16. The method of claim 15, wherein receiving the setting or parameter comprises receiving the setting or parameter from a control functions module.

17. The method of claim 15, wherein receiving the setting or parameter comprises receiving the setting or parameter from an open/closed loop module.

18. The method of claim 15, wherein receiving the setting or parameter comprises receiving the setting or parameter from a ramp up/ramp down module.

19. The method of claim 15, wherein receiving the setting or parameter comprises receiving the setting or parameter from an endpoints module.

20. The method of claim 15, wherein receiving the setting or parameter comprises receiving the setting or parameter from a feedback direction module.
